(19) United States
(12) Patent Application Publication
(10) Pub. No.: US 2020/0274177 A1
(43) Pub. Date: Aug. 27, 2020

(54) FUEL CELL SYSTEM AND HYDROGEN CIRCULATION PUMP

(71) Applicant: KABUSHIKI KAISHA TOYOTA JIDOSHOKKI, Kariya-shi (JP)

(72) Inventors: Fumihiro SUZUKI, Kariya-shi (JP); Tatsuyuki HOSHINO, Kariya-shi (JP)

(73) Assignee: KABUSHIKI KAISHA TOYOTA JIDOSHOKKI, Kariya-shi (JP)

(21) Appl. No.: 16/790,820

(22) Filed: Feb. 14, 2020

(30) Foreign Application Priority Data
Feb. 26, 2019 (JP) 2019-032513

(51) Int. Cl. H01M 8/04089; H01M 8/04082; H01M 8/04746

(52) U.S. Cl. CPC H01M 8/04097; H01M 8/04753; H01M 8/04201

(57) ABSTRACT

A fuel cell system includes a fuel cell stack, a hydrogen supply source, a hydrogen flow passage, a hydrogen recirculation passage, and a hydrogen circulation pump configured to recirculate emission gas containing hydrogen from the fuel cell stack through the hydrogen recirculation passage. The hydrogen circulation pump includes a pump body, a motor, and a housing. The housing internally includes a merge portion that merges the hydrogen recirculation passage with the hydrogen flow passage. The hydrogen flow passage includes a bypass passage that bypasses the merge portion by branching from a portion of the hydrogen flow passage between the hydrogen supply source and the merge portion. The hydrogen flow passage or the bypass passage includes an open degree control valve configured to control a flow rate of hydrogen flowing through the hydrogen flow passage and the bypass passage.

### BACKGROUND

### 1. Field

The following description relates to a fuel cell system and a hydrogen circulation pump.

### 2. Description of Related Art

Japanese Laid-Open Patent Publication No. 2014-232702 discloses a typical fuel cell system. The fuel cell system includes a fuel cell stack, a hydrogen tank, a hydrogen circulation pump, a hydrogen recirculation passage, and a hydrogen flow passage. The fuel cell stack includes fuel cells that are stacked with one another. The hydrogen tank is a hydrogen supply source and stores hydrogen. The hydrogen recirculation passage connects the fuel cell stack to the hydrogen circulation pump. Emission gas containing hydrogen from the hydrogen fuel stack recirculates through the hydrogen recirculation passage. The hydrogen flow passage connects the hydrogen tank to the fuel cell stack. Hydrogen is supplied through the hydrogen flow passage to the fuel cell stack. The hydrogen circulation pump is connected to an intermediate part of the hydrogen recirculation passage.

In the fuel cell system, the hydrogen in the hydrogen tank is supplied through the hydrogen flow passage to the fuel cell system. In the hydrogen fuel stack, the oxygen in the atmosphere electrochemically reacts with hydrogen to generate electricity. Further, emission gas is drawn into the hydrogen circulation pump through the hydrogen recirculation passage and then discharged out of a pump body. The discharged emission gas merges the hydrogen flowing through the hydrogen passage and is supplied again to the fuel cell stack. Thus, the fuel cell system reduces wasteful consumption of hydrogen.

Merging the hydrogen recirculation passage with the hydrogen flow passage in the hydrogen circulation pump simplifies the piping. The simplified piping improves the mountability of the fuel cell system on a device such as a vehicle. However, the electrochemical reaction in the fuel cells causes the generation of heat. Thus, the emission gas has a higher temperature than the hydrogen outside the hydrogen recirculation passage. When the high-temperature emission gas merges with the hydrogen, condensation easily occurs. As a result, when the fuel cell system is not operating, moisture may flow into the pump body. Then, the moisture that has flowed into the pump body freezes when the temperature of the moisture is low. In this case, the pump body may not be able to be activated. In addition, when the amount of condensation water is large, an excessive amount of moisture will be supplied to the fuel cell stack. This causes the moisture to become excessive and results in flooding. The flooding may lower the power-generating efficiency.

### SUMMARY

It is an objective of the present disclosure to provide a fuel cell system that has an excellent mountability for a device and prevents failure caused by condensation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A fuel cell system according to one aspect of the present disclosure includes a fuel cell stack, a hydrogen supply source, a hydrogen flow passage that connects the hydrogen supply source and the fuel cell stack to each other, a hydrogen recirculation passage connected to the fuel cell stack, and a hydrogen circulation pump configured to recirculate emission gas containing hydrogen from the fuel cell stack through the hydrogen recirculation passage. The hydrogen circulation pump includes a pump body, a motor configured to drive the pump body, and a housing that accommodates the pump body and the motor. The housing internally includes a merge portion that merges the hydrogen recirculation passage with the hydrogen flow passage. The hydrogen flow passage includes a bypass passage that bypasses the merge portion by branching from a portion of the hydrogen flow passage between the hydrogen supply source and the merge portion. The hydrogen flow passage or the bypass passage includes an open degree control valve configured to control a flow rate of hydrogen flowing through the hydrogen flow passage and the bypass passage.

Other features and aspects will be apparent from the following detailed description, the drawings, and the claims.

### BRIEF DESCRIPTION OF THE DRAWINGS

FIG. 1 is a vertical cross-sectional view of a hydrogen circulation pump according to a first embodiment.

FIG. 2 is a horizontal cross-sectional view of the hydrogen circulation pump of FIG. 1.

FIG. 3 is a diagram schematically showing the fuel cell system of the first embodiment.

FIG. 4 is a diagram schematically showing part of a fuel cell system according to a second embodiment.

FIG. 5 is a diagram schematically showing part of a fuel cell system according to a third embodiment.

FIG. 6 is a diagram schematically showing part of a fuel cell system according to a fourth embodiment.

FIG. 7 is a vertical cross-sectional view of a hydrogen circulation pump according to a fifth embodiment.

FIG. 8 is a horizontal cross-sectional view of the hydrogen circulation pump of FIG. 7.

FIG. 9 is a diagram schematically showing the fuel cell system of the fifth embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

First to fifth embodiments of the present disclosure will now be described with reference to the drawings.

### First Embodiment

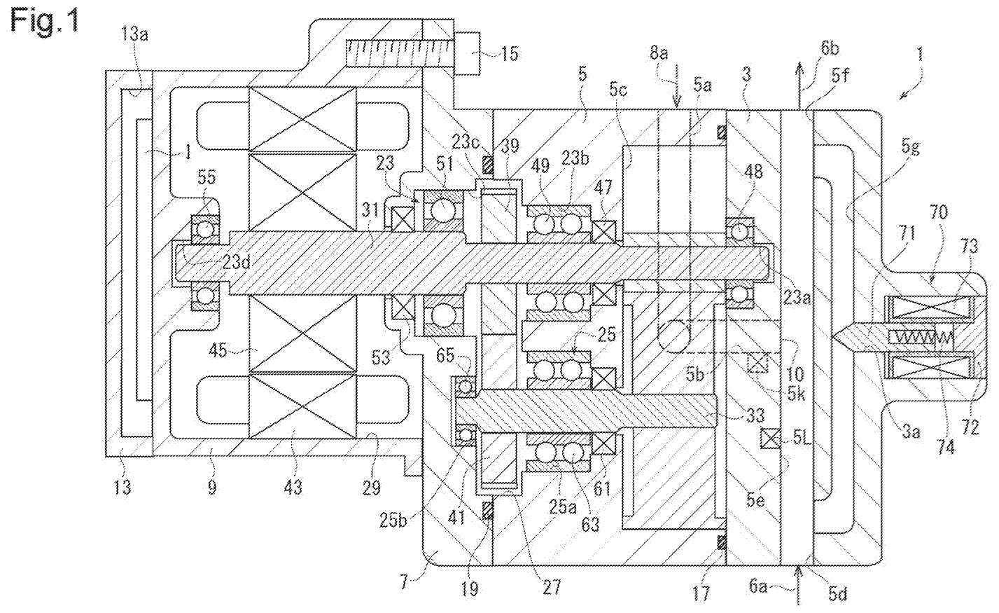

As shown in FIG. 1, the fuel cell system of the first embodiment includes a hydrogen circulation pump 1. The hydrogen circulation pump 1 includes a first rotation shaft 31, a second rotation shaft 33, and a housing. The housing includes, for example, an end housing member 3, a pump housing member 5, a center housing member 7, a motor housing member 9, and an inverter cover 13. These members are arranged in this order along the axis of the first rotation shaft 31. The members of the housing are joined to one another by fixing members such as bolts 15.

An O-ring 17 is arranged between the end housing member 3 and the pump housing member 5. An O-ring 19 is arranged between the pump housing member 5 and the center housing member 7.

As shown in FIGS. 1 to 3, the pump housing member 5 includes a suction port 5a. The end housing member 3 includes an inflow port 5d and a discharge port 5f. The housing includes an inner circulation passage 5b connecting to the suction port 5a. The inner circulation passage 5b is located in the end housing member 3 and the pump housing member 5. The pump housing member 5 includes a pump chamber 5c located at an intermediate part of the inner circulation passage 5b.

The end housing member 3 includes an inner flow passage 5e and a merge portion 10. The inner flow passage 5e extends straight from the inflow port 5d to the discharge port 5f. In the end housing member 3, the inner circulation passage 5b merges with the inner flow passage 5e at the merge portion 10.

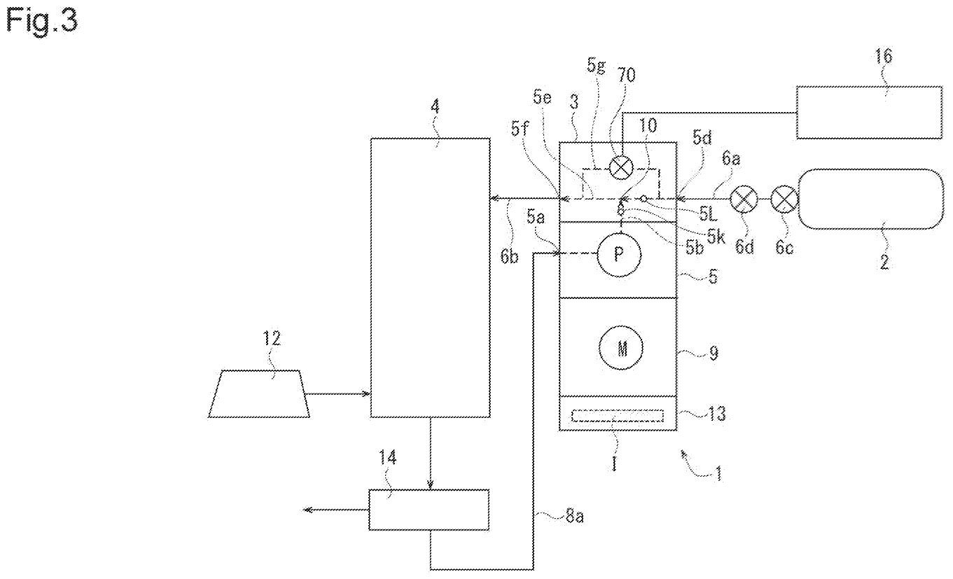

The hydrogen circulation pump 1 includes a temperature sensor 5k and a temperature sensor 5L. The temperature sensor 5k is configured to detect the temperature of emission gas flowing through the inner circulation passage 5b. The temperature sensor 5k is located between the pump chamber 5c and the merge portion 10 in the inner circulation passage 5b. The temperature sensor 5L is located on the upstream side of the merge portion 10 in the inner flow passage 5e. The temperature sensors 5k and 5L are connected to a controller 16 (refer to FIG. 3).

The end housing member 3 includes a bypass passage 5g that connects the inflow port 5d to the discharge port 5f. The upstream end of the bypass passage 5g is connected to the inner flow passage 5e on the upstream side of the merge portion 10. That is, the bypass passage 5g branches from the inner flow passage 5e on the upstream side of the merge portion 10. The downstream end of the bypass passage 5g is connected to the inner flow passage 5e on the downstream side of the merge portion 10. The suction port 5a, the inflow port 5d, and the discharge port 5f open toward the outside of the hydrogen circulation pump 1.

As shown in FIG. 1, the end housing member 3, the pump housing member 5, the center housing member 7, and the motor housing member 9 respectively have shaft holes 23a, 23b, 23c, and 23d. The shaft holes 23a, 23b, 23c, and 23d are circular and coaxial with the first rotation shaft 31. The shaft holes 23a, 23b, 23c, and 23d are entirely used as a first shaft hole 23 of the housing. The first rotation shaft 31 is located in the first shaft hole 23.

The pump housing member 5 and the center housing member 7 respectively have shaft holes 25a and 25b. The shaft holes 25a and 25b are circular and coaxial with the second rotation shaft 33. The shaft holes 25a and 25b are entirely used as a second shaft hole 25 of the housing. The second rotation shaft 33 is located in the second shaft hole 25. The first rotation shaft 31 extends in parallel to the second rotation shaft 33. The axis of the first shaft hole 23 extends in parallel to the axis of the second shaft hole 25.

The pump housing member 5 and the center housing member 7 define a gear chamber 27. The center housing member 7 and the motor housing member 9 define a motor chamber 29.

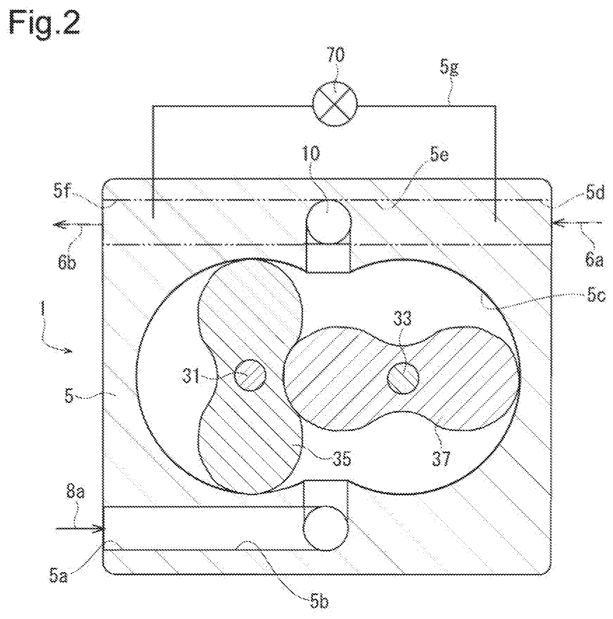

As shown in FIG. 2, the hydrogen circulation pump 1 includes a first rotor 35 and a second rotor 37. The first rotor 35 and the second rotor 37 are respectively fixed to the first rotation shaft 31 and the second rotation shaft 33 in the pump chamber 5c. The first and second rotors 35 and 37 are two-lobe rotors including lobes and recesses that mesh with each other.

As shown in FIG. 1, the hydrogen circulation pump 1 includes a first gear 39, a second gear 41, a stator 43, and a motor rotor 45. The first gear 39 and the second gear 41 are respectively fixed to the first rotation shaft 31 and the second rotation shaft 33 in the gear chamber 27. The first gear 39 and the second gear 41 mesh with each other. The stator 43 and the motor rotor 45 are respectively fixed to the motor housing member 9 and the first rotation shaft 31 in the motor chamber 29.

The shaft hole 23a of the end housing member 3 opens toward the pump chamber 5c. In the shaft hole 23a, a bearing 48 that supports the first rotation shaft 31 is arranged.

The shaft hole 23b of the pump housing member 5 is located between the pump chamber 5c and the gear chamber 27. In the shaft hole 23b, a seal 47 and a bearing 49 are arranged. The seal 47 surrounds the outer circumference of the first rotation shaft 31. The bearing 49 supports the first rotation shaft 31. The seal 47 and the bearing 49 are laid out along the axis of the first rotation shaft 31. The seal 47 is located between the pump chamber 5c and the bearing 49, and the bearing 49 is located between the gear chamber 27 and the seal 47.

The shaft hole 23c of the center housing member 7 is located between the pump chamber 5c and the motor chamber 29. In the shaft hole 23c, a bearing 51 and a seal 53 are arranged. The bearing 51 surrounds the outer circumference of the first rotation shaft 31. The seal 53 supports the first rotation shaft 31. The bearing 51 and the seal 53 are laid out along the axis of the first rotation shaft 31. The bearing 51 is located between the seal 53 and the gear chamber 27, and the seal 53 is located between the bearing 51 and the motor chamber 29.

The shaft hole 23d of the motor housing member 9 opens toward the motor chamber 29. In the shaft hole 23d, a bearing 55 that supports the first rotation shaft 31 is arranged. The bearings 48, 49, 51, and 55 rotationally support the first rotation shaft 31. The seals 47 and 53 restrict the leakage of fluid along the first rotation shaft 31.

The shaft hole 25a of the pump housing member 5 is located between the pump chamber 5c and the gear chamber 27. In the shaft hole 25a, a seal 61 and a bearing 63 are arranged. The seal 61 surrounds the outer circumference of the second rotation shaft 33. The bearing 63 supports the second rotation shaft 33. The seal 61 and the bearing 63 are laid out along the axis of the second rotation shaft 33. The seal 61 is located between the pump chamber 5c and the bearing 63, and the bearing 63 is located between the seal 61 and the gear chamber 27.

The shaft hole 25b of the center housing member 7 opens toward the gear chamber 27. In the shaft hole 25b, a bearing 65 that supports the second rotation shaft 33 is arranged. The bearings 63 and 65 rotationally support the second rotation shaft 33. The seal 61 restricts the leakage of fluid along the second rotation shaft 33.

The hydrogen circulation pump 1 includes a pump body P, a motor M, and an inverter I. The inverter I is an example of a driver. The pump body P includes the first rotation shaft 31, the first rotor 35, the second rotation shaft 33, and the second rotor 37. The pump body P draws emission gas containing hydrogen from the suction port 5a into the inner circulation passage 5b and the pump chamber 5c and forcibly delivers the emission gas in the pump chamber 5c to the merge portion 10 through the inner circulation passage 5b, which is located downstream of the pump body P. The pump body P is located at an intermediate part of the inner circulation passage 5b. Thus, the merge portion 10 is located downstream of the pump body P.

The motor M includes the first rotation shaft 31, the motor rotor 45, and the stator 43. The motor M drives the pump body P. The inverter cover 13 defines an accommodation chamber 13a. The inverter I is fixed in the accommodation chamber 13a. The inverter I controls the motor M.

The hydrogen circulation pump 1 includes an open degree control valve 70 arranged in the end housing member 3. The open degree control valve 70 includes a needle valve 71, a fixed iron core 72, and an electromagnetic coil 73. The end housing member 3 includes a valve hole 3a extending perpendicular to the bypass passage 5g. The needle valve 71 is arranged in the valve hole 3a such that the needle valve 71 is movable back and forth. The fixed iron core 72 and the electromagnetic coil 73 are fixed to the end housing member 3. A spring 74 is arranged between the basal end (right end in FIG. 1) of the needle valve 71 and the fixed iron core 72. The spring 74 is biased in a direction in which the needle valve 71 is projected toward the bypass passage 5g. The electromagnetic coil 73 is arranged so as to surround the vicinity of the basal end of the needle valve 71.

The electromagnetic coil 73 is connected to the controller 16 (refer to FIG. 3). When the electromagnetic coil 73 is excited by an output signal of the controller 16, the needle valve 71 moves toward the fixed iron core 72 against a biasing force of the spring 74. Movement of the needle valve 71 toward the fixed iron core 72 causes fluid to flow through the bypass passage 5g. When the electromagnetic coil 73 is not excited, the needle valve 71 closes the bypass passage 5g to restrict the passage of fluid. Additionally, the cross-sectional flow area (i.e., open degree) of the bypass passage 5g is changed in accordance with the distance of movement of the needle valve 71 toward the fixed iron core 72.

As shown in FIG. 3, the fuel cell system of the first embodiment includes the hydrogen circulation pump 1. The fuel cell system includes the hydrogen circulation pump 1, the hydrogen tank 2 that is a hydrogen supply source, a fuel cell stack 4, a compressor 12 that supplies oxidizing gas, a gas-liquid separator 14, a hydrogen flow passage, and a hydrogen recirculation passage. The hydrogen tank 2 stores hydrogen in the state of high-pressure gas. The fuel cell stack 4 includes fuel cells that are stacked with one another.

The hydrogen flow passage includes an upstream flow pipe 6a, the inner flow passage 5e, and a downstream flow pipe 6b. The hydrogen recirculation passage includes a hydrogen recirculation pipe 8a and the inner circulation passage 5b. The hydrogen recirculation pipe 8a connects the fuel cell stack 4, the gas-liquid separator 14, and the suction port 5a of the hydrogen circulation pump 1 to each other in this order.

The upstream flow pipe 6a connects the hydrogen tank 2 to the inflow port 5d of the hydrogen circulation pump 1. The downstream flow pipe 6b connects the discharge port 5f of the hydrogen circulation pump 1 to the fuel cell stack 4. The upstream flow pipe 6a includes a hydrogen shut-off valve 6c and a hydrogen supply adjustment valve 6d. The hydrogen shut-off valve 6c and the hydrogen supply adjustment valve 6d are connected to the controller 16.

When the hydrogen shut-off valve 6c opens, the hydrogen in the hydrogen tank 2 is supplied to the hydrogen circulation pump 1 through the upstream flow pipe 6a. The hydrogen supply adjustment valve 6d adjusts the supply amount of hydrogen. The hydrogen drawn in by the hydrogen circulation pump 1 from the inflow port 5d is delivered through the inner flow passage 5e and the bypass passage 5g to the discharge port 5f. The hydrogen circulation pump 1 discharges the hydrogen from the discharge port 5f to the downstream flow pipe 6b. In this manner, the hydrogen is supplied to the fuel cell stack 4. Further, the compressor 12 supplies oxidizing gas to the fuel cell stack 4. In the fuel cell stack 4, electricity is generated through the electrochemical reaction of hydrogen and oxygen in the oxidizing gas.

Emission gas containing hydrogen from the fuel cell stack 4 is supplied to the gas-liquid separator 14 through the hydrogen recirculation pipe 8a. The gas-liquid separator 14 discharges, to the outside, reaction generation water contained in the emission gas. The emission gas from which the reaction generation water has been removed is conveyed to the hydrogen circulation pump 1 through the hydrogen recirculation pipe 8a. The hydrogen circulation pump 1 draws the emission gas through the suction port 5a into the inner circulation passage 5b and the pump chamber 5c. The emission gas discharged from the pump chamber 5c merges with the hydrogen flowing through the inner flow passage 5e at the merge portion 10 and discharged from the discharge port 5f to the downstream flow pipe 6b. Thus, the fuel cell system reduces wasteful consumption of hydrogen by recirculating emission gas.

The housing of the hydrogen circulation pump 1 includes the suction port 5a, the inner circulation passage 5b, the inflow port 5d, the inner flow passage 5e, the merge portion 10, and the discharge port 5f Thus, in the housing, emission gas is delivered from the suction port 5a to the pump body P, and the hydrogen in the hydrogen tank 2 is delivered from the inflow port 5d to the inner flow passage 5e. The emission gas in the inner circulation passage 5b merges with the hydrogen in the inner flow passage 5e, and the hydrogen is discharged from the discharge port 5f to the fuel cell stack 4. This simplifies the piping of the fuel cell stack 4, the hydrogen tank 2, and the hydrogen circulation pump 1. This allows the fuel cell system to be mounted in a device such as a vehicle in a favorable manner.

The temperature sensor 5k detects the temperature of pre-merged emission gas flowing through the inner circulation passage 5b and sends the information related to the temperature to the controller 16. The temperature sensor 5L detects the temperature of hydrogen from the hydrogen tank 2 flowing through the inner flow passage 5e and sends the information related to the temperature to the controller 16. Since the merge portion 10 is located downstream of the pump body P, the emission gas that has reached the merge portion 10 is increased in temperature by the pump body P.

The controller 16 changes the open degree of the bypass passage 5g in accordance with the temperatures detected by the temperature sensors 5k and 5L taking into account various types of information such as the information related to at least one of the external temperature and the driving condition. This adjusts the flow rate of the bypass passage 5g and the flow rate of the inner flow passage 5e.

For example, when the temperature difference between the hydrogen from the hydrogen tank 2 flowing through the inner flow passage 5e and the emission gas from the fuel cell stack 4 flowing through the inner circulation passage 5b is greater than a threshold value, the controller 16 decreases the flow rate of the inner flow passage 5e in order to limit condensation. When the temperature difference between the hydrogen from the hydrogen tank 2 and the emission gas from the fuel cell stack 4 is less than the threshold value, the controller 16 increases the flow rate of the inner flow passage 5e.

Taking the above-described various information into account, when determining that the temperature difference between the hydrogen from the hydrogen tank 2 and the emission gas from the fuel cell stack 4 is so small that condensation does not occur, the controller 16 sends a signal for reducing the open degree to the open degree control valve 70. In this case, the needle valve 71 is moved by a biasing force of the spring 74 in a direction in which the open degree of the bypass passage 5g decreases. This reduces the flow rate of the hydrogen flowing through the bypass passage 5g and increases the flow rate of the hydrogen flowing through the inner flow passage 5e.

When determining that the temperature difference between the hydrogen from the hydrogen tank 2 and the emission gas from the fuel cell stack 4 is so large that condensation occurs, the controller 16 sends a signal for increasing the open degree to the open degree control valve 70. In this case, the needle valve 71 moves toward the fixed iron core 72 to increase the open degree of the bypass passage 5g. This increases the flow rate of the hydrogen flowing from the hydrogen tank 2 through the bypass passage 5g and reduces the flow rate of the hydrogen passing through the inner flow passage 5e. As a result, the temperature difference between the hydrogen flowing through the inner flow passage 5e and the emission gas flowing through the inner circulation passage 5b decreases. This prevents condensation at the merge portion 10.

The fuel cell system of the first embodiment simplifies the piping for merging the hydrogen recirculation passage with the hydrogen flow passage. Further, the generation of condensation water caused by the hydrogen discharged toward the fuel cell stack 4 is limited by changing the flow rate of low-temperature hydrogen merging at the merge portion 10 of the hydrogen circulation pump 1.

As a result, when the fuel cell system is not operating, the inflow of moisture in the merge portion 10 is limited. This limits the freezing of condensation water at a low temperature and improves the startability of the pump body P at a low temperature. Additionally, the supply of moisture in the merge portion 10 to the fuel cell stack 4 is limited. This limits the occurrence of flooding in the fuel cell stack 4 and improves the power-generating efficiency.

Accordingly, the fuel cell system is excellent in the mountability for a device such as a vehicle and prevents failure caused by condensation.

In the first embodiment, since the merge portion 10 and the bypass passage 5g are arranged in the hydrogen circulation pump 1, the piping is significantly simplified. In the arrangement of the bypass passage 5g in the hydrogen circulation pump 1, the bypass passage 5g, where low-temperature hydrogen flows, is located away from the merge portion 10 although the total amount of hydrogen flowing from the hydrogen tank 2 through the hydrogen circulation pump 1 remains unchanged. This limits condensation at the merge portion 10. Even if condensation occurs on the wall surface in the vicinity of the bypass passage 5g, the inflow of condensation water into the pump body P is restricted by the merging of the bypass passage 5g with the inner flow passage 5e on the downstream side of the merge portion 10.

The bypass passage 5g may be entirely or partially arranged in the hydrogen circulation pump 1. This simplifies the piping. The arrangement of the open degree control valve 70 in the housing also simplifies the piping.

### Second Embodiment

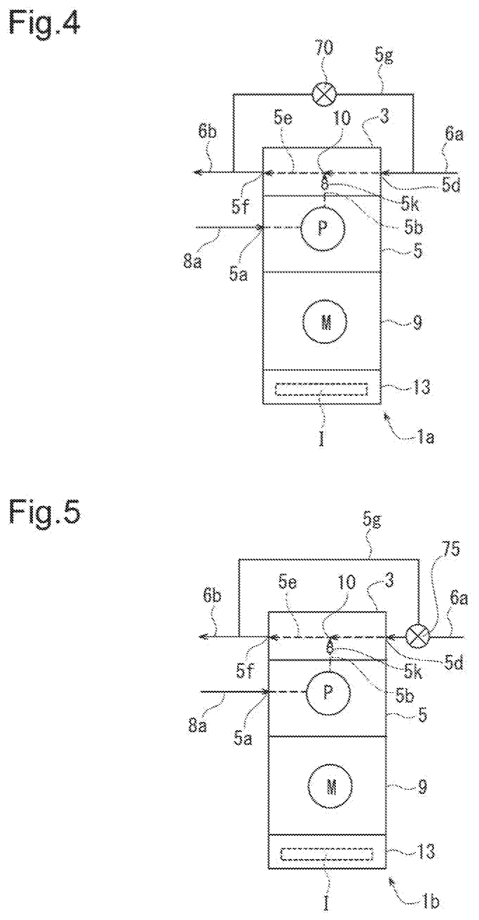

FIG. 4 shows a fuel cell system according to a second embodiment. As shown in FIG. 4, the bypass passage 5g and the open degree control valve 70 of the second embodiment are arranged outside the end housing member 3. The bypass passage 5g connects the upstream flow pipe 6a to the downstream flow pipe 6b. The upstream end of the bypass passage 5g is connected to an intermediate part of the upstream flow pipe 6a located upstream of the merge portion 10. The downstream end of the bypass passage 5g is connected to an intermediate part of the downstream flow pipe 6b located downstream of the merge portion 10.

The fuel cell system of the second embodiment does not include the temperature sensor 5L and includes only the temperature sensor 5k, which detects the temperature of emission gas in the inner circulation passage 5b. The other sections of the second embodiment have the same configuration as the first embodiment.

The fuel cell system of the second embodiment provides the same advantage as that of the first embodiment.

### Third Embodiment

FIG. 5 shows a fuel cell system according to a third embodiment. As shown in FIG. 5, the fuel cell system of the third embodiment includes an open degree control valve 75. The open degree control valve 75 is a three-way valve arranged between the bypass passage 5g and the upstream flow pipe 6a. In the same manner as the second embodiment, the upstream end of the bypass passage 5g is connected to an intermediate part of the upstream flow pipe 6a located upstream of the merge portion 10, and the downstream end of the bypass passage 5g is connected to an intermediate part of the downstream flow pipe 6b located downstream of the merge portion 10. The bypass passage 5g and the open degree control valve 75 may be arranged inside or outside the end housing member 3 of a hydrogen circulation pump 1b. The open degree control valve 75 is capable of simultaneously controlling the open degree of the upstream flow pipe 6a and the open degree of the bypass passage 5g. The other sections of the third embodiment have the same configuration as the first embodiment.

The fuel cell system of the third embodiment provides the same advantage as that of the second embodiment.

### Fourth Embodiment

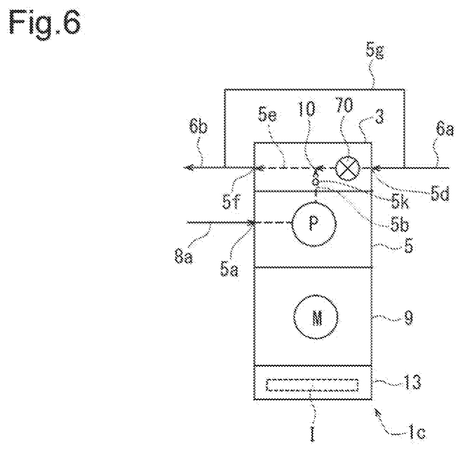

FIG. 6 shows a fuel cell system according to a fourth embodiment. As shown in FIG. 6, the fuel cell system of the fourth embodiment includes the open degree control valve 70 that is arranged upstream of the merge portion 10 in the inner flow passage 5e. The bypass passage 5g and the open degree control valve 70 may be arranged inside or outside the end housing member 3 of a hydrogen circulation pump 1c. The other sections of the fourth embodiment have the same configuration as the first embodiment.

The fuel cell system of the fourth embodiment provides the same advantage as those of the first to third embodiment.

### Fifth Embodiment

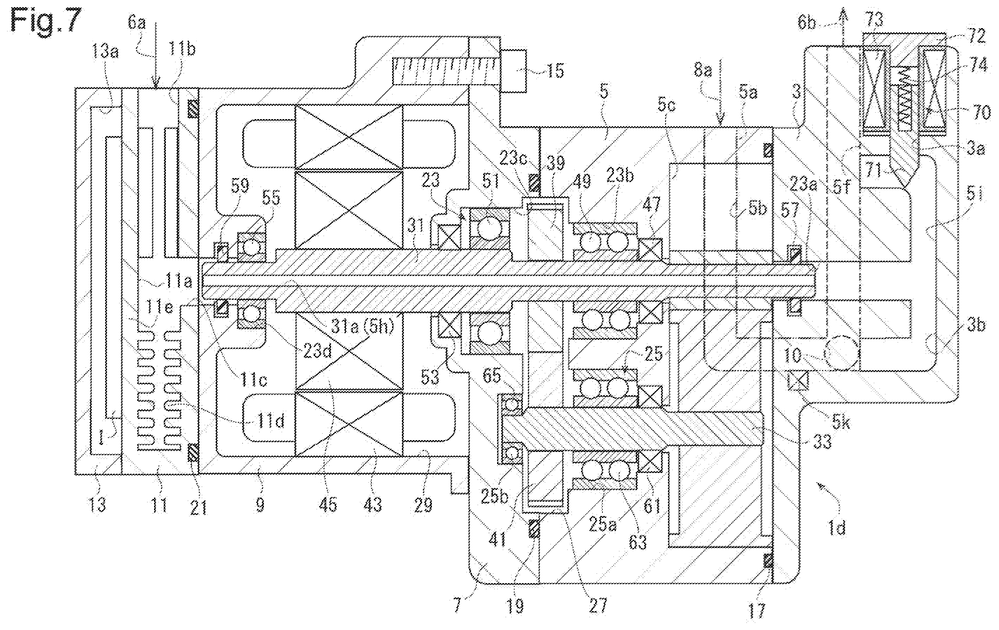

FIG. 7 shows a fuel cell system according to a fifth embodiment. As shown in FIG. 7, a hydrogen circulation pump 1d of the fifth embodiment includes a cooling housing member 11 arranged between the motor housing member 9 and the inverter cover 13. An O-ring 21 is arranged between the motor housing member 9 and the cooling housing member 11. The housing of the fifth embodiment includes the end housing member 3, the pump housing member 5, the center housing member 7, the motor housing member 9, the cooling housing member 11, and the inverter cover 13.

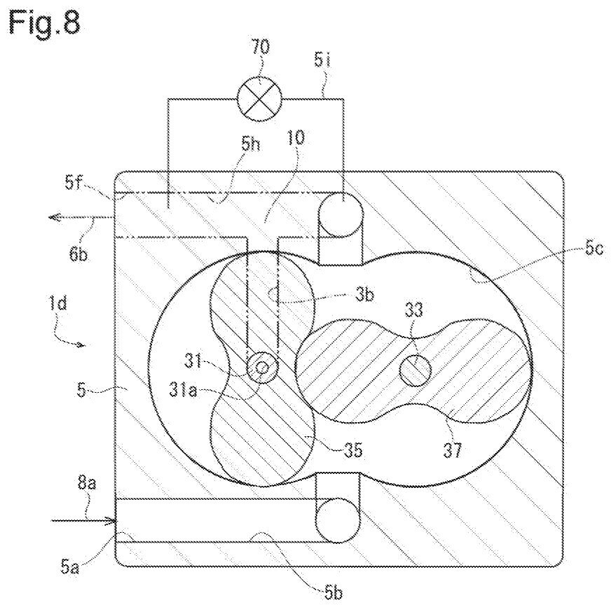

The shaft hole 23a has a first end (right end in FIG. 7) and a second end (left end in FIG. 7) in the axial direction of the first rotation shaft 31. The housing of the fifth embodiment includes a connection passage 3b connecting to the first end of the shaft hole 23a. The connection passage 3b is located in the end housing member 3 and the pump housing member 5. As shown in FIG. 8, the connection passage 3b connects to the inner circulation passage 5b at the merge portion 10.

As shown in FIG. 7, the shaft hole 23d has a first end (right end in FIG. 7) and a second end (left end in FIG. 7) in the axial direction of the first rotation shaft 31. The cooling housing member 11 includes a cooling chamber 11a connecting to the second end of the shaft hole 23d. The cooling housing member 11 further includes a partition wall 11e that is in contact with the inverter cover 13.

The housing of the fifth embodiment includes an inner flow passage 5h that is a hydrogen flow passage. Hydrogen flowing through the inner flow passage 5h exchanges heat with the inverter I through the partition wall 11e on the upstream side of the merge portion 10.

The cooling housing member 11 has an inflow port 11b and an outflow port 11c. The inflow port 11b and the outflow port 11c connect to the cooling chamber 11a. The inflow port 11b opens toward the outside of the hydrogen circulation pump 1d. The upstream flow pipe 6a is connected to the inflow port 11b.

The first rotation shaft 31 of the fifth embodiment includes a shaft passage 31a that extends through the first rotation shaft 31 in the axial direction. The shaft passage 31a extends along the axis of the first rotation shaft 31. The shaft passage 31a has a first end (right end in FIG. 7) and a second end (left end in FIG. 7) in the axial direction. The outflow port 11c connects to the second end of the shaft passage 31a. The cooling housing member 11 includes fins 11d, which protrude in the cooling chamber 11a.

The shaft hole 23d of the motor housing member 9 is located between the motor chamber 29 and the cooling chamber 11a. In the shaft hole 23d, the bearing 55, which supports the first rotation shaft 31, and a chip seal 59 made of polytetrafluoroethylene (PTFE) are arranged. The bearing 55 and the chip seal 59 are laid out along the axis of the first rotation shaft 31. The chip seal 59 is arranged between the outflow port 11c and the bearing 55.

In the shaft hole 23a of the end housing member 3, a chip seal 57 made of PTFE is arranged to surround the outer circumference of the first rotation shaft 31. The first rotation shaft 31 of the fifth embodiment is rotationally supported by the bearings 49, 51, and 55. The chip seals 57 and 59 and the seals 47 and 53 restrict the leakage of fluid along the first rotation shaft 31.

The first end of the shaft passage 31a connects to the connection passage 3b. The cooling chamber 11a connects to the connection passage 3b through the shaft passage 31a. The chip seals 59 and 57 restrict the hydrogen in the cooling chamber 11a from leaking into the first shaft hole 23. This causes the hydrogen in the cooling chamber 11a to be discharged out of the discharge port 5f through the shaft passage 31a and the connection passage 3b. The inner flow passage 5h includes the inflow port 11b, the cooling chamber 11a, the outflow port 11c, the shaft passage 31a, the connection passage 3b, and the discharge port 5f In the end housing member 3, the inner flow passage 5h merges with the inner flow passage 5e at the merge portion 10.

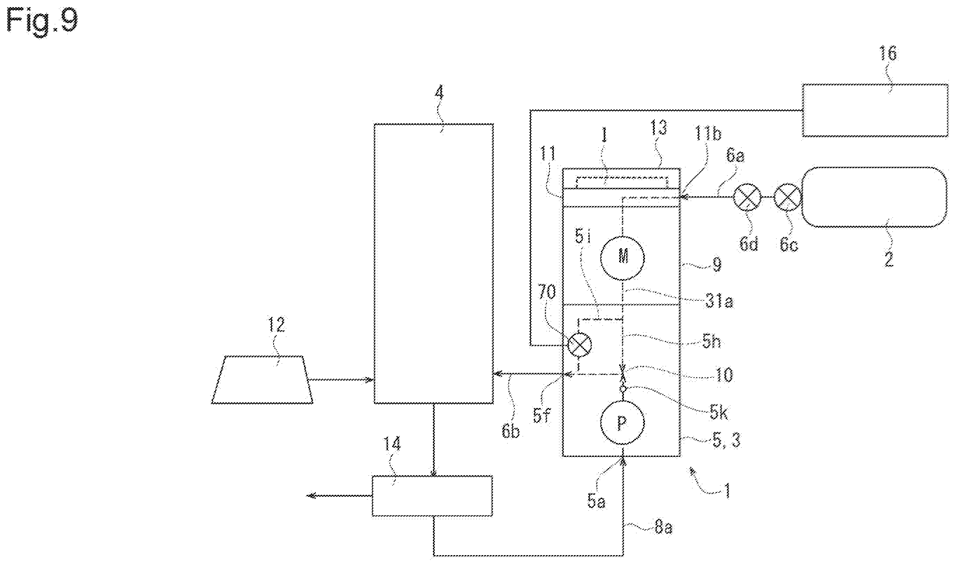

As shown in FIGS. 7 to 9, the end housing member 3 includes a bypass passage 5i. The upstream end of the bypass passage 5i is connected to the inner flow passage 5h on the upstream side of the merge portion 10. The downstream end of the bypass passage 5i is connected to the inner flow passage 5h between the merge portion 10 and the discharge port 5f The end housing member 3 includes the open degree control valve 70 that is capable of controlling the open degree of the bypass passage 5i. The other sections of the fifth embodiment have the same configuration as the first embodiment. Like or the same reference numerals are given to those components that are like or the same as the corresponding components of the first embodiment. Such components will not be described in detail.

The fuel cell system of the fifth embodiment provides the same advantage as the fuel cell system(s) of the above-described embodiment(s).

In the fuel cell system of the fifth embodiment, the hydrogen in the hydrogen tank 2 flows through the upstream flow pipe 6a from the inflow port 11b into the cooling chamber 11a. The hydrogen that has flowed into the cooling chamber 11a passes through the shaft passage 31a and the connection passage 3b and merges with the emission gas flowing through the inner circulation passage 5b at the merge portion 10. That is, the hydrogen in the inner flow passage 5h merges with the emission gas in the inner circulation passage 5b at the merge portion 10 and then flows through the discharge port 5f to the downstream flow pipe 6b. The low-temperature hydrogen supplied from the hydrogen tank 2 cools the partition wall 11e in the cooling chamber 11a, and the partition wall 11e further cools the inverter I. Additionally, the low-temperature hydrogen in the shaft passage 31a cools the first rotation shaft 31. This limits the generation of heat caused by frictional heat of the first rotation shaft 31 and limits the generation of heat in the motor M. This improves the durability of the hydrogen circulation pump 1.

Accordingly, in addition to the above-described advantage, the fuel cell system of the fifth embodiment lowers a decrease in the durability.

The present disclosure is not limited to the first to fifth embodiments and may be modified within the scope of the invention.

In the first to fifth embodiments, the merge portion 10 is located downstream of the pump body P. Instead, for example, the merge portion 10 may be located upstream of the pump body P.

In the first to fifth embodiments, the arrangement of the motor M and the pump body P may be changed. For example, in the first embodiment, the arrangement of the motor M and the pump body P may be reversed.

In the first to fifth embodiments, the hydrogen supply source does not have to be the hydrogen tank 2 that stores hydrogen and may be a device or a passage capable of supplying hydrogen to the fuel cell stack 4.

The upstream flow pipe 6a connected to the hydrogen tank 2 may include passages routed through the hydrogen circulation pumps 1, 1a, 1b, 1c, 1d and passages that are branched from the routed passages and directly connected to the fuel cell stack 4.

The arrangement of one or more temperature sensors may be changed. For example, the temperature sensor(s) may be arranged only in the inner flow passage 5e. Alternatively, the temperature sensor(s) may be arranged in the downstream flow pipe 6b.

In the first embodiment, an insulator may be arranged between the inner flow passage 5e and the pump body P. The insulator further increases the effect of limiting the generation of condensation.

In the first embodiment, when the temperature difference between the hydrogen from the hydrogen tank 2 and the emission gas from the fuel cell stack 4 is less than the threshold value, the flow rate of the inner flow passage 5e does not have to be increased and may be maintained.

The open degree control valve 70, 75 may be controlled an open degree in accordance with the information related to at least one of the temperature of the hydrogen flowing through the hydrogen flow passage and the temperature of the emission gas flowing through the hydrogen recirculation passage.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A fuel cell system comprising:
a fuel cell stack;
a hydrogen supply source;
a hydrogen flow passage that connects the hydrogen supply source and the fuel cell stack to each other;
a hydrogen recirculation passage connected to the fuel cell stack; and
a hydrogen circulation pump configured to recirculate emission gas containing hydrogen from the fuel cell stack through the hydrogen recirculation passage, wherein
the hydrogen circulation pump includes
a pump body,
a motor configured to drive the pump body, and
a housing that accommodates the pump body and the motor,
the housing internally includes a merge portion that merges the hydrogen recirculation passage with the hydrogen flow passage, and
the hydrogen flow passage includes a bypass passage that bypasses the merge portion by branching from a portion of the hydrogen flow passage between the hydrogen supply source and the merge portion, and
the hydrogen flow passage or the bypass passage includes an open degree control valve configured to control a flow rate of hydrogen flowing through the hydrogen flow passage and the bypass passage.

2. The fuel cell system according to claim 1, wherein the open degree control valve is arranged on the bypass passage.

3. The fuel cell system according to claim 1, wherein the open degree control valve is arranged on the hydrogen flow passage.

4. The fuel cell system according to claim 1, wherein the housing includes at least part of the bypass passage.

5. The fuel cell system according to claim 1, wherein the open degree control valve is configured to control an open degree in accordance with information related to at least one of a temperature of hydrogen flowing through the hydrogen flow passage or a temperature of emission gas flowing through the hydrogen recirculation passage.

6. The fuel cell system according to claim 1, wherein the merge portion is located downstream of the pump body.

7. A hydrogen circulation pump for the fuel cell system according to claim 1.
